(19) United States
(12) Patent Application Publication
(10) Pub. No.: US 2025/0196669 A1
(43) Pub. Date: Jun. 19, 2025

(54) Hybrid Electric Vehicle Garage Charger

(71) Applicant: The Noco Company, Glenwillow, OH (US)

(72) Inventor: James Richard Stanfield, Glendale, AZ (US)

(21) Appl. No.: 18/981,853

(22) Filed: Dec. 16, 2024

Related U.S. Application Data
(60) Provisional application No. 63/611,942, filed on Dec. 19, 2023.

(51) Int. Cl. B60L 53/10; B60K 6/28; B60L 53/62; H02J 7/00; H02J 7/02

(52) U.S. Cl. CPC B60L 53/11; B60K 6/28; B60L 53/62; H02J 7/0063; H02J 7/00712; H02J 7/02; B60L 2210/10; B60Y 2200/92; B60Y 2300/91; B60Y 2400/112; H02J 2207/20

(57) ABSTRACT

A hybrid electric vehicle (EV) charger may comprise a plurality of battery modules having a predetermined energy capacity. The plurality of battery modules may be configured to receive AC power and to charge based on the AC power. Each of the plurality of battery modules may be configured to generate a battery module output signal having a first predetermined voltage level. The hybrid EV charger may further comprise a DC-DC converter configured to receive the battery module output signal from the plurality of battery modules and generate a first EV charging signal having a first predetermined current level and a second EV charging signal for a predetermined time period. The second EV charging signal may have a second predetermined current level greater than the first predetermined current level. The first EV charging signal and the second EV charging signal may be configured to charge a battery of an EV.

### CROSS-REFERENCE TO RELATED APPLICATION

This application claims priority to U.S. Provisional Application No. 63/611,942, filed on Dec. 19, 2023, the entirety of which is incorporated herein by reference.

### TECHNICAL FIELD

The present disclosure relates to charging devices and systems for charging electrical vehicles (EVs).

### BACKGROUND

An electric vehicle (EV) charging system can be used to charge a battery of an EV.

### SUMMARY

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

In an example, a hybrid electric vehicle (EV) charger comprises a plurality of battery modules having a predetermined energy capacity. Each of the plurality of battery modules may be configured to receive AC power and to charge based on the AC power. Each of the plurality of battery modules may be further configured to generate a battery module output signal having a first predetermined voltage level. The hybrid EV charger may further comprise a DC-DC converter configured to receive the battery module output signal from each of the plurality of battery modules and generate a first EV charging signal having a first predetermined current level. The DC-DC converter may be further configured to generate a second EV charging signal for a predetermined time period. The second EV charging signal may have a second predetermined current level greater than the first predetermined current level. The first EV charging signal and the second EV charging signal may be configured to charge a battery of an EV.

In another example, an EV charging system comprises a battery module including a plurality of individual batteries connected in series. Each of the plurality of individual batteries may generate a first predetermined voltage. The battery module may generate a battery module output signal having a second predetermined voltage level that is substantially the sum of each of the first predetermined voltage of the individual batteries. The EV charging system may further include a DC-DC converter configured to receive the battery module output signal and generate a first EV charging signal having a first current level. The DC-DC converter may be further configured to generate a second EV charging signal for a predetermined time period. The second EV charging signal may have a second current level greater than the first current level. The EV charging system may further include a fast charge connector having a first end coupled to the DC-DC converter and a second end configured to attach to an EV. The fast charge connector may be configured to receive the first EV charging signal or the second EV charging signal and charge the EV with the first EV charging signal or the second EV charging signal.

In another example, a method of charging an EV comprises storing DC power in a battery module. The method may further comprise generating a battery module output signal having a first predetermined voltage level. The method may further comprise receiving the battery module output signal. The method may further comprise based on the battery module output signal, generating a first EV charging signal in a standard charging mode. The first EV charging signal may have a first current level. The method may further include based on the battery module output signal, generating a second EV charging signal in a fast charging mode. The second EV charging signal may have a second current level greater than the first current level. The method may further include charging the EV based on the first EV charging signal or the second EV charging signal.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 depicts a block diagram of a hybrid EV charger, in accordance with some embodiments.

FIG. 2 depicts a charging system having a step-up DC-DC converter, in accordance with some embodiments.

FIG. 3 depicts an EV charging system having a plurality of individual batteries connected in series, in accordance with some embodiments.

FIG. 4 depicts a method of charging an EV, in accordance with some embodiments.

### DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying figures may vary without departing from the scope of the present disclosure.

Electric vehicles (EVs) are becoming increasingly popular. A standard method of everyday or routine charging of an EV may be by a Level 2 charger. For situations in which a user of the EV must charge the EV faster than that allowed by a Level 2 charger, the user of the EV may charge the EV with a charger capable of charging the EV more quickly (e.g., at a fast-charging station). Fast-charging stations can be located far away from a residential Level 2 charger. Thus, driving to a fast-charging station may waste valuable time, which can be disadvantageous if the user is in a hurry. Furthermore, waiting for others to charge their EVs at a commercial fast-charging station can waste time. In many cases, the user of the EV may need to quickly add driving range to their EV, but may not have the time to travel to a fast-charging station. Therefore, there is a need for EV users to quickly add range in a residential charging environment.

The power available in a standard residential home may be insufficient to charge the EV with charging parameters necessary to quickly add driving range to the EV. For example, the current available in many residential homes may be limited to a predetermined amount (e.g., 100 amperes or, for newer homes, 200 amperes). Power in residential homes may be received as 240 VAC split phase. Accordingly, the maximum power available in residential homes by conventional methods may be 24 KW (240 VAC×100 Amps) or 48 KW (240 VAC×200 Amps). However, the power required by a fast-charging station may be greater than the power available in residential homes by conventional methods (e.g., 72 KW, 100 KW, 150 KW, or 250 KW). Thus, even if all the power in a standard home were dedicated to the fast-charging station, it may be insufficient to charge an EV at the power levels of a fast-charging station.

Systems and methods disclosed herein include storing energy from a residential home in batteries. When combined with a DC-DC converter, the energy stored in the batteries may provide energy comparable to that of a fast-charging station (e.g., 150 KW) for a limited period of time. The battery capacity of the systems and methods disclosed herein may be large enough to quickly distribute approximately 50 miles of range or more to the EV.

A capacity of a battery system may be determined based on an example of a typical EV. As an example, a typical Tesla Model Y has a battery capacity of approximately 80 KWh. This size battery may provide the EV user with approximately 315 miles of driving range. Therefore, to design a system providing 50 miles of driving range to an EV, the battery capacity of the EV may need to be increased by 50 miles 315 miles≈16%. In the example in which the battery capacity of the Tesla Model Y is approximately 80 KWh, this increase corresponds to approximately 12.8 KWh. The voltage of a Tesla Model Y battery may be 400 VDC. The charge capacity (in Amp-hours) of the Tesla Model Y battery may be calculated by dividing the electrical energy of the battery by the battery voltage. Thus, the charge capacity of the Tesla Model Y battery may be 80,000 Wh÷400 V=200 Ah.

If a charging system included a storage battery having a similar battery voltage as the EV battery it was charging (e.g., the battery of the Tesla Model Y), the calculation to determine the necessary charge capacity of the storage battery may be the charge capacity of the EV battery multiplied by the percentage increase in driving range required: 200 Ah×16%=32 Ah. If the battery of the charging system were designed with a lower voltage (e.g., 100 VDC), the battery capacity would need to be stepped up (e.g., boosted) (e.g., by a factor of 4 for an EV battery having a 400 VDC battery). In such a case, the charge capacity required by the storage batteries may be increased proportionately (e.g., 32 Ah×4=128 Ah). Thus, for a storage battery having a voltage of 100 VDC, the energy capacity of the storage capacity would be approximately 100 VDC×128 Ah=12.8 KWh. If a DC-DC converter is used to regulate the voltage and current in the vehicle, an efficiency factor may need to be considered. For example, for a DC-DC converter having an efficiency of 90%, the energy capacity may need to be increased by approximately 100%−90%=10%. Thus, the actual energy capacity required by the storage battery may be 14.08 KWh. It should be understood that the examples presented above are to demonstrate clarity of methodology. For those skilled in the art, it is understood that the storage battery voltage should be scaled for optimal voltage matching to the target EV. This may be necessary to limit the boost ratio and minimize DC/DC conversion losses. Storage battery voltage scalability and capacity scalability are central to any given deployment scheme.

In another example, a charging system may include storage batteries with a higher voltage level than an EV battery it is charging. In such a charging system, the voltage of the storage batteries may need to be stepped down (e.g., bucked). For example, the voltage of the storage batteries may be bucked by a DC-DC converter prior to charging the EV battery. For example, nine (9) 48V battery packs may be connected in series. This may be result in a charging voltage of 9×48V=432 VDC. Using the same energy capacity calculated above of 12.8 KWh, the necessary battery charge capacity of the storage batteries can be calculated as 12.8 KWh÷432 VDC=29.6 Ah. In one example, a charging system may be designed with a single DC-DC converter, battery modules that include individual batteries, and a charger to re-charge the batteries when they are depleted.

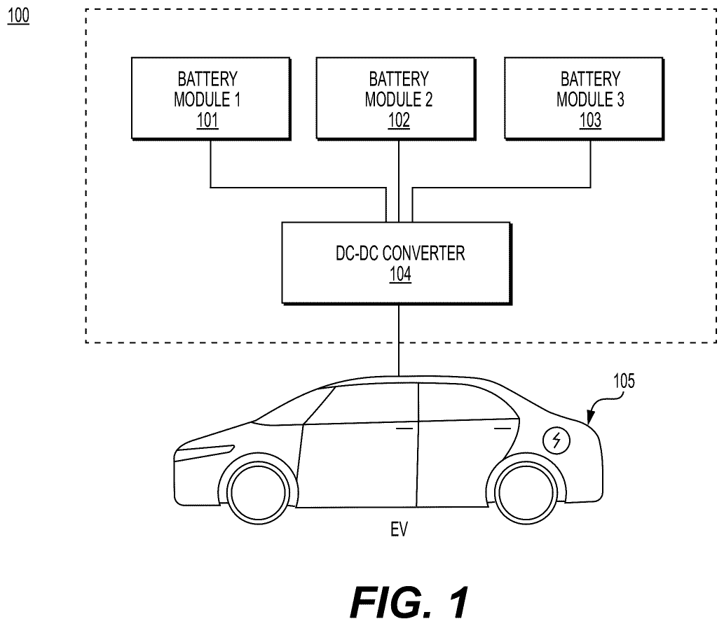

FIG. 1 depicts a block diagram of a hybrid EV charger, in accordance with some embodiments. In the example shown in FIG. 1, the hybrid EV garage charger 100 includes a first battery module 101, a second battery module 102, and a third battery module 103. The hybrid EV garage charger 100 may further include a DC-DC converter 104. In the example shown in FIG. 1, the battery modules 101, 102, 103 may each have an energy capacity of approximately 12.8 KWh, as described above. Each battery module 101, 102, 103 may include a plurality of individual batteries. For example, the individual batteries may be connected in series to generate the total energy capacity of the battery module. The battery modules 101, 102, 103 may be connected to a power grid (not shown). For example, an AC-DC converter (not shown) may receive AC power from the power grid and generate DC charging current. The DC charging current may be received by and may be used to charge the battery modules 101, 102, 103. As discussed above, the voltage of each battery module 101, 102, 103 may be approximately 432 VDC.

Each battery module 101, 102, 103 may generate a battery module output signal. The battery module output signal from each battery module may be received by the DC-DC converter 104. Based on the battery module output signal, the DC-DC converter may generate an EV charging signal. In the example shown in FIG. 1, the DC-DC converter 104 may be a step-down (e.g., buck) DC-DC converter. The DC-DC converter 104 may receive the battery module output signal having a voltage of 432 VDC and may generate an EV charging signal having a voltage of, for example, 400 VDC. The EV charging signal may be received by an EV 105 (e.g., a Tesla Model Y). The hybrid EV garage charger 100 may charge the EV 105 based on the EV charging signal.

As described above, it may be advantageous to quickly charge an EV in a residential charging environment. Therefore, it may be useful to calculate necessary charging parameters for charging an EV in a predetermined amount of time. In the example described above, the energy capacity of an EV battery may be approximately 80 KWh. The driving range of the EV with a fully charged EV battery may be approximately 315 miles. As described above, for a charging system having a similar voltage as the voltage of the EV battery it is charging (e.g., 400 VDC), it may be necessary to supply approximately 13 KWh to the EV battery to add 50 miles of range to the EV battery. For a charging system having a voltage of 400 VDC and a charging current of approximately 32.5 A, the charging system may need to charge the EV battery for approximately 1 hour to add the necessary 13 KWh of charge capacity to the EV battery. However, the charging current may be increased to reduce the charging time proportionately. For example, a charging system charging an EV battery with 130 A at 400V may be able to add 50 miles of range to the EV battery in only 15 minutes. Charging an EV with these parameters may be considered charging the EV in a fast charging mode. This may be, for example, Level 3 charging.

In some examples, the hybrid EV charger may be configured to charge the EV more slowly. This may be useful, for example, when a user of the EV has more time available to charge the EV. Therefore, the DC-DC converter 104 may be further configured to generate an EV charging signal having a current less than the current supplied to the EV in the fast charging mode (e.g., 30 A). Charging the EV with these parameters may be considered a standard charging mode. The voltage of the EV charging signal during a standard charging mode may be less than or may be substantially the same as the voltage of the EV charging signal during the fast charging mode. The DC-DC converter may be configured to generate an EV charging signal having parameters for charging the EV in the standard charging mode and to generate an EV charging signal having parameters for charging the EV in the fast charging mode. A user of the hybrid EV charger may select between charging the EV in a standard charging mode or a fast charging mode. The mode may be selected, for example, by a knob or a switch on the hybrid EV charger.

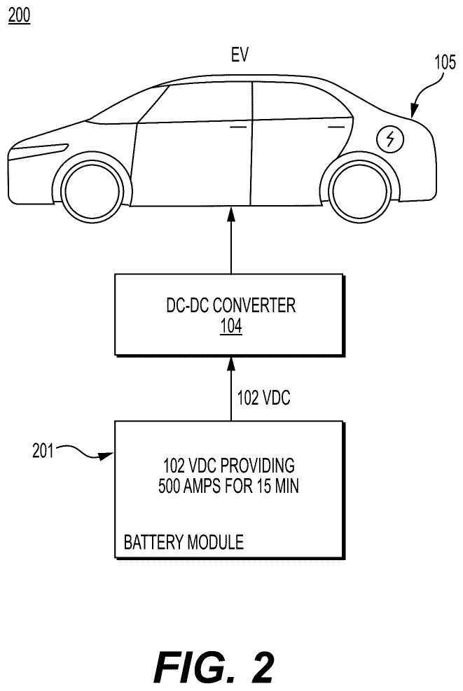

FIG. 2 depicts a charging system having a step-up DC-DC converter, in accordance with some embodiments. In the example shown in FIG. 2, the EV charging system 200 may be configured to charge an EV 105 in a fast charging mode. The EV charging system 200 may include a battery module 201 having an operating voltage of 102 VDC. The battery module 201 may be configured to supply 500 A of output current for 15 minutes. The DC-DC converter 104 may be configured to receive the 500 A of output current from the battery module 201 at 102 VDC. The DC-DC converter may increase (e.g., “boost”) the received voltage from 102 VDC to 400 VDC. This may be an increase by a factor of approximately 3.92. The DC-DC converter 104 may generate an EV charging signal having a current that is reduced by substantially the same factor by which the received voltage is increased. For example, the current suppled to the DC-DC converter 104 may be decreased by a factor of approximately 3.92. The EV charging signal may thus have a voltage of approximately 400 VDC and a current of approximately 130 A. These parameters may be used to charge the battery of the EV 105 and add approximately 50 miles of range to the EV within about 15 minutes. In some example embodiments, the battery module 201 may supply an output current of approximately 250 A for 30 minutes or approximately 127 A for 1 hour to add 50 miles of driving range to the EV 105. It should be understood that the examples provided above are to demonstrate clarity of methodology. For those skilled in the art, it is understood that the storage battery voltage should be scaled for optimal voltage matching to the target EV. This may be necessary to limit the boost ratio and minimize DC/DC conversion losses. Storage battery voltage scalability and capacity scalability are central to any given deployment scheme.

The EV charging system may be further configured to charge the EV 105 in the standard charging mode, as discussed above with respect to FIG. 1. For example, the battery module 201 may be configured to supply a lower current compared with the current supplied by the battery module 201 in the fast charging mode. Therefore, the DC-DC converter 104 may generate an EV charging signal having a current that is lower than the current of the EV charging signal during the fast charging mode.

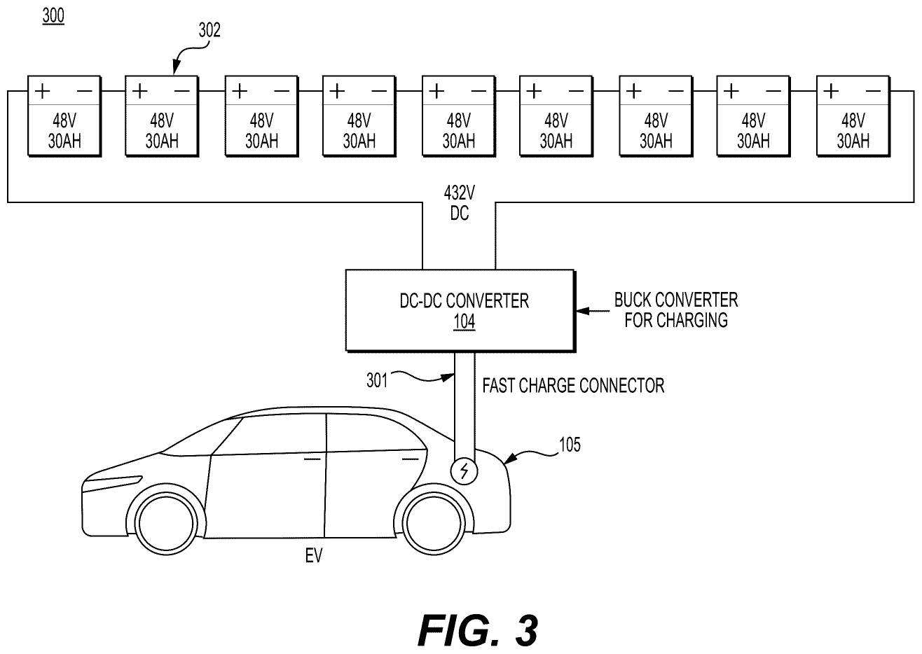

FIG. 3 depicts an EV charging system having a plurality of individual batteries connected in series, in accordance with some embodiments. In the example shown in FIG. 3, the EV charging system 300 includes nine (9) individual batteries 302 having a voltage of 48 VDC and a charge capacity of 30 Ah. The 9 individual batteries 302 in the EV charging system 300 connected in series may generate an output voltage of approximately 432 VDC. The output voltage of the individual batteries 302 connected in series may be received by the DC-DC converter 104. In the example shown in FIG. 3, the DC-DC converter 104 may be a step-down (e.g., “buck”) converter. For example, the DC-DC converter 104 may be used to decrease the voltage received from the series individual batteries 302 to the charging voltage of the EV battery (e.g., 400V). The DC-DC converter 104 may generate an EV charging signal. A fast charge connector 301 may be coupled to an output side of the DC-DC converter 104 and may attach to the EV 105 to charge the EV battery. The fast charge connector 301 may charge the EV battery with the EV charging signal. An EV charging system using a step-down DC-DC converter 104 may be more efficient and result in less power loss than an EV charging system using a step-up DC-DC converter. As discussed above, the DC-DC converter 104 depicted in FIG. 3 may be used to generate an EV charging signal having parameters for charging an EV in a standard charging mode (e.g., 30 A and 400 VDC) and for charging an EV in a fast charging mode (e.g., 130 A and 400 VDC) based on a user input.

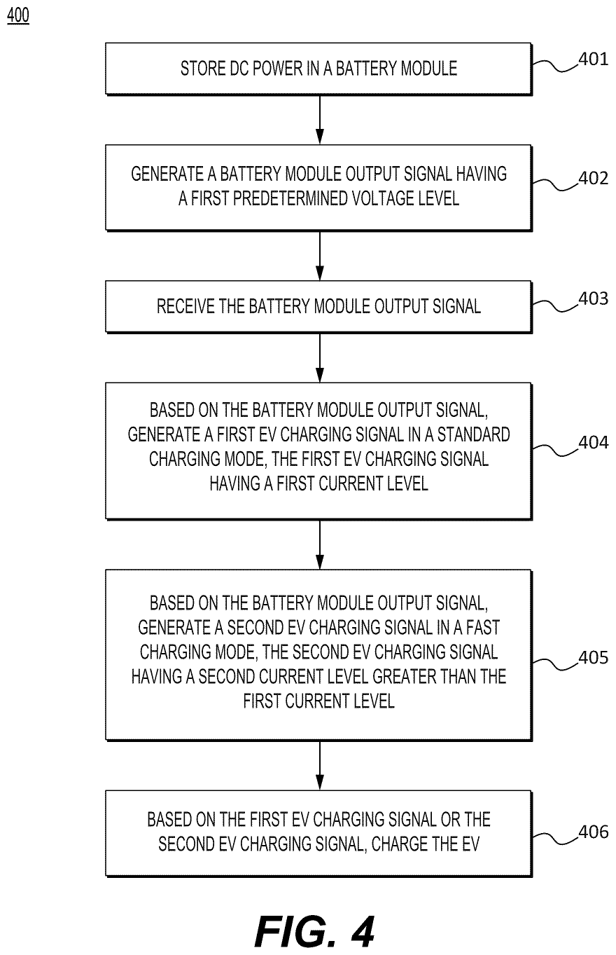

FIG. 4 depicts a method of charging an EV, in accordance with some embodiments. In the example depicted in FIG. 4, the method 400 includes a first step 401 of storing DC power in a battery module. The method 400 may further include a second step 402 of generating a battery module output signal having a first predetermined voltage level. The method 400 may further include a third step 403 of receiving the battery module output signal. The method 400 may further include a fourth step 404 of based on the battery module output signal, generating a first EV charging signal in a standard charging mode. The first EV charging signal may have a first current level. The method 400 may further include a fifth step 405 of based on the battery module output signal, generating a second EV charging signal in a fast charging mode. The second EV charging signal may have a second current level greater than the first current level. The method 400 may further include a sixth step 406 of based on the first EV charging signal or the second EV charging signal, charging the EV.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, the term “including” means including but not limited to. The term “based on” means based at least in part on.”

What is claimed is:

1. A hybrid electric vehicle (EV) charger comprising:
a plurality of battery modules having a predetermined energy capacity, each of the plurality of battery modules configured to receive AC power and to charge based on the AC power, each of the plurality of battery modules further configured to generate a DC battery module output signal having a first predetermined voltage level;
a DC-DC converter configured to receive the DC battery module output signal from each of the plurality of battery modules and generate a first EV charging signal having a first predetermined current level, the DC-DC converter further configured to generate a second EV charging signal for a predetermined time period, the second EV charging signal having a second predetermined current level greater than the first current level, wherein the first EV charging signal and the second EV charging signal are configured to charge a battery of an EV.

2. The hybrid EV charger of claim 1, wherein the first EV charging signal supplies Level 2 charging to the EV and the second EV charging signal supplies Level 3 charging to the EV.

3. The hybrid EV charger of claim 1, wherein the first EV charging signal and the second EV charging signal have a second predetermined voltage level, the second predetermined voltage level based on a charging voltage of the EV.

4. The hybrid EV charger of claim 3, wherein the second predetermined voltage level is greater than the first predetermined voltage level.

5. The hybrid EV charger of claim 3, wherein the second predetermined voltage level is lower than the first predetermined voltage level.

6. The hybrid EV charger of claim 1, wherein the AC power is 120 VAC.

7. An electric vehicle (EV) charging system comprising:
a battery module including a plurality of individual batteries connected in series, each of the plurality of individual batteries generating a first predetermined voltage, the battery module generating a battery module output signal having a second predetermined voltage level that is substantially the sum of each of the first predetermined voltage of the individual batteries;
a DC-DC converter configured to receive the battery module output signal and generate a first EV charging signal having a first current level, the DC-DC converter further configured to generate a second EV charging signal for a predetermined time period, the second EV charging signal having a second current level greater than the first current level; and
a fast charge connector having a first end coupled to the DC-DC converter and a second end configured to attach to an EV, the fast charge connector configured to receive the first EV charging signal or the second EV charging signal and to charge the EV with the first EV charging signal or the second EV charging signal.

8. The EV charging system of claim 7, wherein the first EV charging signal and the second EV charging signal have a third predetermined voltage level based on a charging voltage of the EV.

9. The EV charging system of claim 8, wherein the third predetermined voltage level is lower than the second predetermined voltage level.

10. The EV charging system of claim 8, wherein the third predetermined voltage level is greater than the second predetermined voltage level.

11. The EV charging system of claim 7, wherein the first predetermined voltage level is 48V.

12. The EV charging system of claim 7, wherein the charge capacity of each individual battery is substantially 30 Amp hours.

13. The EV charging system of claim 7, wherein the charging system is configured to generate the first EV charging signal or the second EV charging signal based on a selection of a user of the EV charging system.

14. A method of charging an electric vehicle (EV) comprising:
storing DC power in a battery module;
generating a battery module output signal having a first predetermined voltage level;
receiving the battery module output signal;
based on the battery module output signal, generating a first EV charging signal in a standard charging mode, the first EV charging signal having a first current level;
based on the battery module output signal, generating a second EV charging signal in a fast charging mode, the second EV charging signal having a second current level greater than the first current level; and
based on the first EV charging signal or the second EV charging signal, charging the EV.

15. The method of claim 14, further comprising charging the battery module with 120 VAC power.

16. The method of claim 14, further comprising selecting the first EV charging signal or the second EV charging signal based on a user input.

17. The method of claim 14, wherein the first EV charging signal and the second EV charging signal have a second predetermined voltage level different from the first predetermined voltage level, the second predetermined voltage level based on a charging voltage of the EV.

18. The method of claim 17, wherein the first predetermined voltage level is greater than the second predetermined voltage level.

19. The method of claim 17, wherein the first predetermined voltage level is lower than the second predetermined voltage level.
